(19) United States
(12) Patent Application Publication
(10) Pub. No.: US 2009/0085899 A1
(43) Pub. Date: Apr. 2, 2009

(54) CAPACITIVE LOAD DRIVING CIRCUIT AND PLASMA DISPLAY PANEL

(76) Inventors: Hiroshi ANDO, Osaka (JP); Seiya Yoshida, Kyoto (JP); Hiroki Matsunaga, Osaka (JP); Jinsaku Kaneda, Osaka (JP)

Correspondence Address: MCDERMOTT WILL & EMERY LLP, 600 13TH STREET, NW, WASHINGTON, DC, 20005-3096, US

(21) Appl. No.: 12/181,595

(22) Filed: Jul. 29, 2008

(30) Foreign Application Priority Data
Sep. 28, 2007 (JP) 2007-253780

(51) Int. Cl. G09G 5/00; G09G 3/28

(52) U.S. Cl. 345/205; 345/60

(57) ABSTRACT

A scan driving circuit includes: a shift register section receiving a scan data signal and a scan clock signal; a plurality of pulse width control circuits each receiving an output signal from the shift register section and a negative pulse width control signal to output a signal whose pulse width is controlled based on the negative pulse width control signal; a blanking section receiving the output signals from the plurality of pulse width control circuits and a blanking signal; and a plurality of high voltage output sections for amplifying the output signals from the plurality of pulse width control circuits, which are received via the blanking section, to successively output negative pulses each having a controlled pulse width to the scanning electrodes.

### BACKGROUND OF THE INVENTION

1. Field of the Invention

The present invention relates to a semiconductor integrated circuit, and more particularly to a driving circuit for a multi-channel semiconductor integrated circuit for driving a capacitive load, such as a plasma display.

2. Description of the Background Art

A conventional capacitive load circuit for driving electrodes, such as a plasma display panel (hereinafter referred to as a “PDP”) will be described with reference to the drawings.

FIG. 9 shows a configuration of a typical conventional AC-type PDP. Referring to FIG. 9, the conventional PDP includes a panel 1007, data electrodes 1004 provided on the panel 1007, a data driving section 1001 for driving the data electrodes 1004, erase/sustain electrodes 1006, an erase/sustain driving section 1003 for driving the erase/sustain electrodes 1006, scanning electrodes 1005 extending across above the panel 1007, a scan driving section 1002 for driving the scanning electrodes 1005, and the scan driving section 1002. The scan driving section 1002 is controlled by a scan data signal 1008, a scan clock signal 1009 and a scan blanking signal 1010.

FIG. 10 shows a configuration of the scan driving section 1002 in the conventional PDP shown in FIG. 9. Referring to FIG. 10, the scan driving section 1002 includes a shift register section 1011, a blanking section 1012, and a high voltage output section 1013. The shift register section 1011 delays, by clocks, the input scan data signal 1008 based on the scan clock signal 1009 to thereby output a signal of the opposite polarity to that of the input signal. The blanking section 1012 receives the outputs from the shift register section 1011 and the scan blanking signal 1010, and simultaneously brings the outputs to the positive polarity irrespective of the input to the shift register section 1011, based on the scan blanking signal 1010. The high voltage output section 1013 receives the outputs from the blanking section 1012.

FIG. 11 shows a specific example of the shift register section 1011. Referring to FIG. 11, the conventional shift register section 1011 includes a plurality of flip flops (clock synchronization delaying circuits) 1021-1, 1021-2, 1021-3, 1021-4, . . . , connected together in series, and inverter elements 1022-1, 1022-2, 1022-3, 1022-4, . . . , connected to the input sections of the corresponding flip flops. The scan data signal 1008 is input to the clock synchronization delaying circuit 1021-1. The scan clock signal 1009 is input to the clock synchronization delaying circuits 1021-1, 1021-2, 1021-3, 1021-4, . . . . With this configuration, there is obtained an output of the opposite polarity to that of the input scan data signal 1008.

Referring now to FIG. 12, an operation of the scan driving section 1002 will be described. FIG. 12 shows the waveforms of the input and output signals of the conventional scan driving section.

The scan data signal 1008 is transferred by clock cycles based on the scan clock signal 1009, whereby negative pulses are sequentially output from output terminals OUT1, OUT2, . . . . In the illustrated example, the high level period of the scan data signal 1008 is within the clock cycle, and the output terminals OUT1, OUT2, . . . , sequentially output negative pulses each being one clock cycle long, based on the scan clock signal 1009. There is provided a delay time td from the rising edge of the scan clock signal 1009 until the output section of the scan driving section 1002 outputs a negative pulse. If td can be made longer than rise time tr for the output to return from negative to positive, there will be no overlap between negative portions of adjacent outputs.

FIG. 13A schematically shows a circuit operation of the conventional PDP on the panel, and FIG. 13B shows the waveforms of negative pulses applied to the corresponding scanning electrodes.

Referring to FIGS. 13A and 13B, the negative pulses are sequentially applied to scanning electrodes 1005-1, 1005-2, 1005-3, 1005-4, . . . . When a negative pulse is applied to the data electrode 1004, virtual capacitors 1203-1, 1203-2, 1203-3, 1203-4, . . . , appear between the scanning electrodes and the data electrode. When a negative pulse is applied to the data electrode 1004, a charge is stored in the virtual capacitors between the electrodes. As a result, light is emitted through a plasma discharge at intersections A and B between the data electrode 1004 and the scanning electrodes 1005-1 and 1005-3, for example. Then, referring to FIGS. 14A and 14B, the erase/sustain electrodes 1006 and the scanning electrodes 1005-1, 1005-2, 1005-3, 1005-4, . . . , are simultaneously activated and controlled in an AC-like manner, whereby virtual capacitors 1204-1, 1204-2, 1204-3, 1204-4, . . . , appear between the erase/sustain electrodes 1006 and the scanning electrodes 1005-1, 1005-2, 1005-3, 1005-4, . . . , thus stabilizing the light-emitting potential at intersections A and B and sustaining the light emission while keeping the charge being stored. This light mission determines the color and the brightness of the panel.

Higher-definition PDPs have been introduced and TV broadcasting has transitioned to digital, allowing for high-vision signals to be transmitted, thus increasing the number of scanning lines and the number of pixels accordingly. As a result, there are cases now where the screen is undesirably dark, as it is not possible to ensure a sufficient length of the light emission sustaining period unless the frequency of the scan clock signal is increased.

In order to solve this problem, Japanese Patent No. 3539291 discloses a circuit as shown in FIG. 15. FIG. 15 is a circuit diagram schematically showing a configuration of a second conventional PDP.

Referring to FIG. 15, the second conventional PDP includes an odd/even-separated scan driving section 1102 that separately receives a blanking input 1114 for controlling odd-numbered lines and a blanking input 1115 for controlling even-numbered lines. Otherwise, the configuration is the same as that of the first conventional PDP shown in FIG. 9.

FIG. 16 shows a specific configuration of the odd/even-separated scan driving section of the second conventional PDP. Referring to FIG. 16, the odd/even-separated scan driving section 1102 includes the shift register section 1011 receiving the scan data signal 1008 and the scan clock signal 1009, an odd-number blanking section 1112 receiving the blanking input 1114 for controlling odd-numbered lines and signals from the odd-numbered lines of the shift register section 1011, an even-number blanking section 1113 receiving the blanking input 1115 for controlling even-numbered lines and signals from the even-numbered lines of the shift register section 1011, and the high voltage output section 1013 receiving outputs from the odd-number blanking section 1112 and the even-number blanking section 1113.

An operation of the second conventional PDP will now be described.

FIG. 17 shows the waveforms of the input and output signals of the odd/even-separated scan driving section 1102 shown in FIG. 16. In the example shown in FIG. 17, two clock cycles worth of data is input to the odd/even-separated scan driving section 1102, and the blanking operation is performed while shifting the phase of the blanking input 1114 for controlling odd-numbered lines from that of the blanking input 1115 for controlling even-numbered lines, thereby obtaining a negative pulse width of one clock cycle or more both for the odd-numbered lines and for the even-numbered lines. With this method, it is possible to ensure a relatively long light emission sustaining time even if the frequency of the scan clock signal is increased.

### SUMMARY OF THE INVENTION

With the configuration of the second conventional PDP, however, it may not be possible to simultaneously control odd-numbered lines and even-numbered lines, and the control of the odd-numbered lines and the control of the even-numbered lines need to be done separately from each other and with respect to each other, in order to enable an arbitrary adjustment of the pulse width. Therefore, adjustments to clock frequency changes, and the like, cannot be done easily.

The present invention has been made in view of the problem as set forth above, and has an object to provide a PDP capable of accommodating an increase or a change in the clock frequency, and capable of individually adjusting the widths of the negative pulses applied to the scanning electrodes.

In order to achieve the object set forth above, the present invention is directed to a scanning capacitive load driving circuit for driving a plurality of lines of scanning electrodes arranged in a display section, including: a shift register section receiving a scan data signal and a scan clock signal; a plurality of pulse width control circuits each receiving an output signal from the shift register section and a negative pulse width control signal to output a signal whose pulse width is controlled based on the negative pulse width control signal; a blanking section receiving the output signals from the plurality of pulse width control circuits and a blanking signal; and a plurality of high voltage output sections for amplifying the output signals from the plurality of pulse width control circuits, which are received via the blanking section, to successively output negative pulses each having a controlled pulse width to the corresponding lines of scanning electrodes.

With such a configuration, it is possible to arbitrarily adjust the width of the negative pulse applied to the scanning electrode, by using the negative pulse width control signal being a single control signal. Therefore, adjustments to clock frequency changes, and the like, can be done more easily, as compared with a case where the scanning electrode driving section is divided into one section for even-numbered lines and another section for odd-numbered lines. Moreover, scanning electrodes of the odd-numbered lines and those of the even-numbered lines will not be driven at the same time, thereby enabling a line-by-line arbitrary adjustment. Moreover, even if the frequency of the scan clock signal is increased, the width of the negative pulse can be set to be equal to or longer than one clock cycle, and it is thus possible to ensure a sufficient light emission sustaining time on a plasma display panel.

Moreover, the gain of the high voltage output section is varied based on the negative pulse width control signal for a predetermined period of time at the rise of the negative pulse. Thus, the rise of the negative pulse can be made sharper, whereby it is possible to shorten the amount of time required for the negative pulse to rise.

The present invention is also directed to a plasma display panel, including: a display section; a plurality of lines of scanning electrodes arranged in the display section, wherein at least negative pulses are applied to the scanning electrodes; a plurality of lines of erase/sustain electrodes arranged in the display section; scan data electrodes extending across the scanning electrodes and the erase/sustain electrodes; and a scanning capacitive load driving circuit for driving the scanning electrodes, wherein the scanning capacitive load driving circuit includes: a shift register section receiving a scan data signal and a scan clock signal; a plurality of pulse width control circuits each receiving an output signal from the shift register section and a negative pulse width control signal to output a signal whose pulse width is controlled based on the negative pulse width control signal; a blanking section receiving the output signals from the plurality of pulse width control circuits and a blanking signal; and a plurality of high voltage output sections for amplifying the output signals from the plurality of pulse width control circuits, which are received via the blanking section, to successively output the negative pulses each having a controlled pulse width to the corresponding lines of scanning electrodes.

With such a configuration, the width of the negative pulse applied to the scanning electrode can be adjusted based on the negative pulse width control signal, whereby it is possible to ensure a sufficient light emission time even if the clock frequency is increased. Moreover, adjustments to changes in the scan clock signal frequency, and the like, can be done more easily.

### BRIEF DESCRIPTION OF THE DRAWINGS

FIG. 1 schematically shows a configuration of a PDP according to a first embodiment of the present invention.

FIG. 2 is a block diagram showing a configuration of a scan driving section in the PDP of the first embodiment.

FIG. 3 is a block diagram showing a configuration of a pulse width control circuit in the scan driving section of the first embodiment.

FIG. 4A shows a specific configuration of the pulse width control circuit shown in FIG. 3, FIG. 4B is a truth table for a latch circuit, FIG. 4C is a truth table for a NAND logic element, and FIG. 4D is a truth table for a pulse width control block as a whole.

FIG. 5 is a timing diagram showing waveforms of input and output signals of the scan driving section of the first embodiment.

FIG. 6 is a block diagram showing a configuration of a scan driving section (a capacitive load driving circuit) according to a second embodiment of the present invention.

FIG. 7A shows a configuration of a variable-gain high voltage output section in the scan driving section of the second embodiment, and FIG. 7B is a timing diagram showing the signal waveforms of the variable-gain high voltage output section.

FIG. 8 is a timing diagram showing waveforms of input and output signals of the scan driving section of the second embodiment.

FIG. 9 shows a configuration of a typical conventional AC-type PDP.

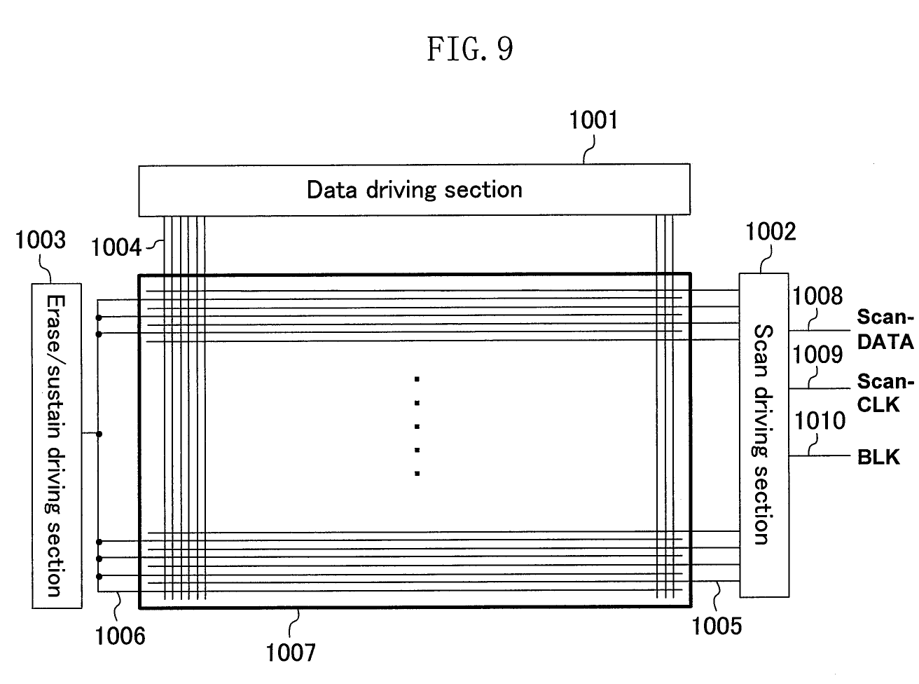

FIG. 10 shows a configuration of the scan driving section in the conventional PDP shown in FIG. 9.

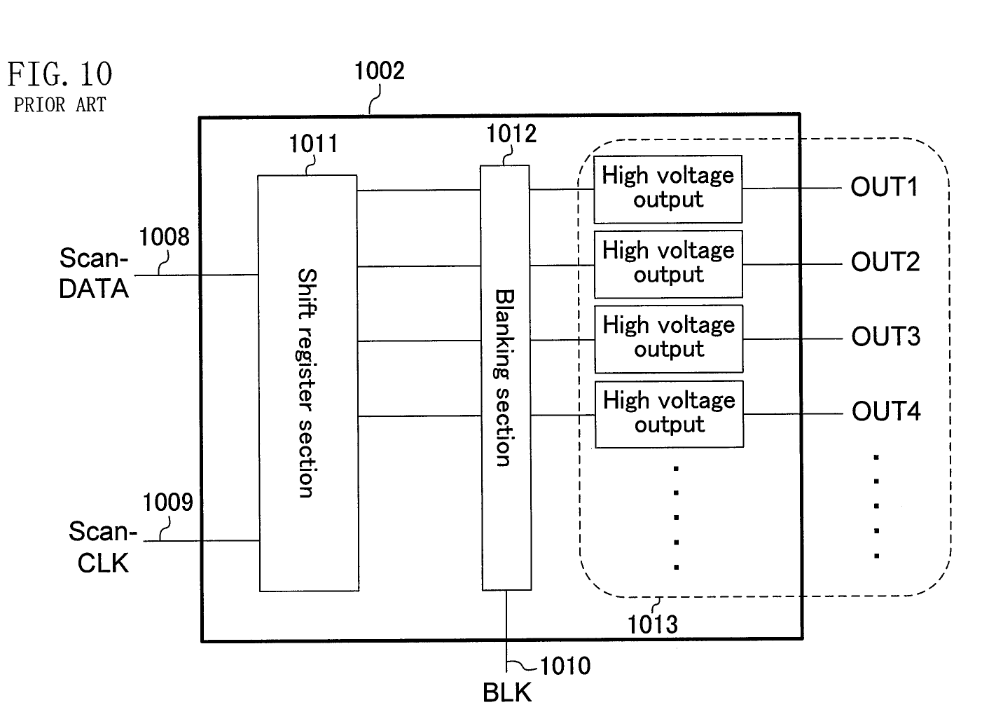

FIG. 11 shows a specific example of a shift register section of the conventional PDP.

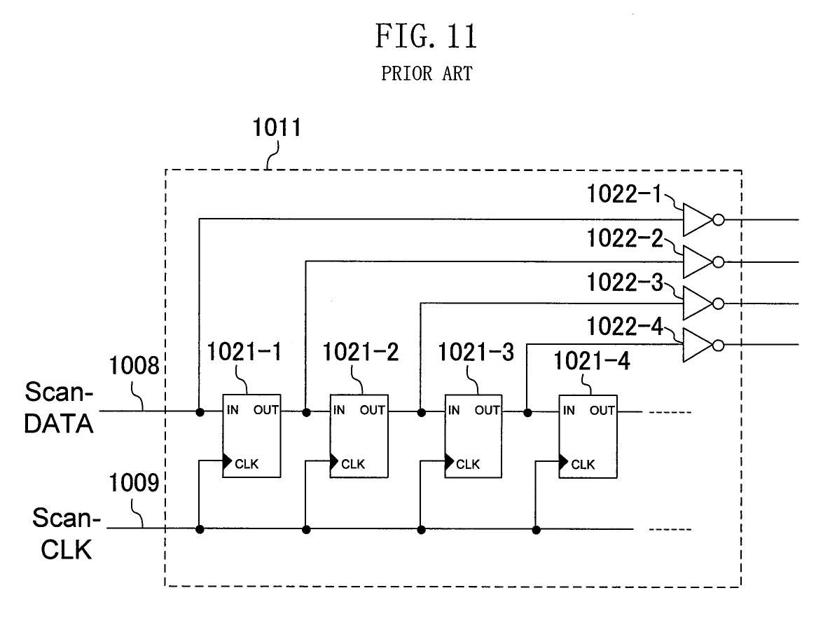

FIG. 12 is a timing diagram showing waveforms of input and output signals of the conventional scan driving section.

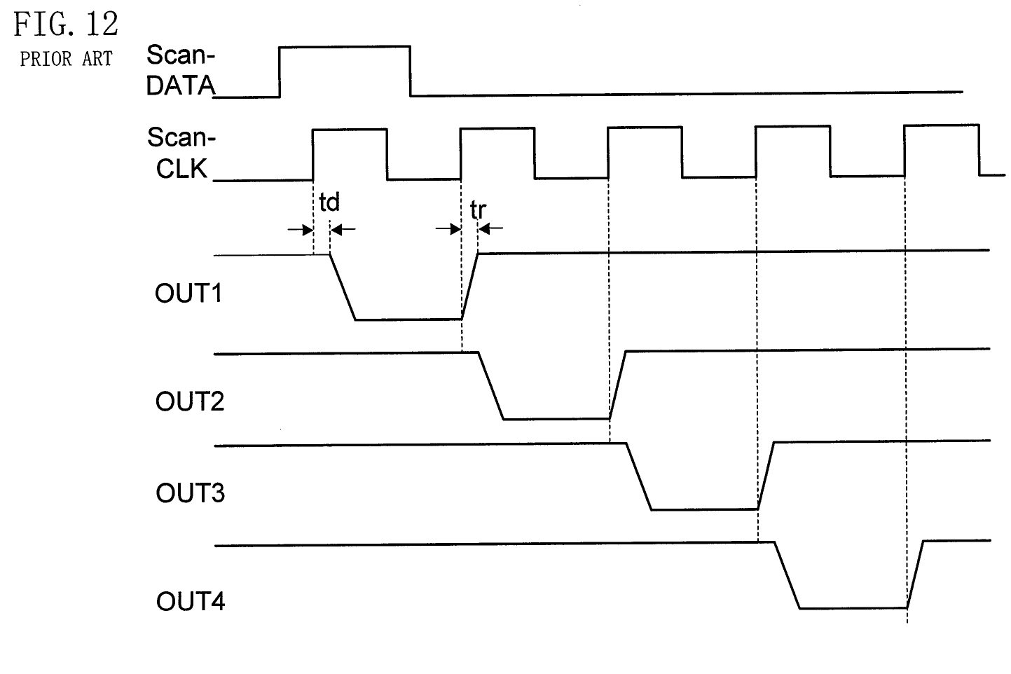

FIG. 13A schematically shows a circuit operation of the conventional PDP on the panel at the time of a light-emitting discharge, and FIG. 13B shows waveforms of negative pulses applied to different scanning electrodes.

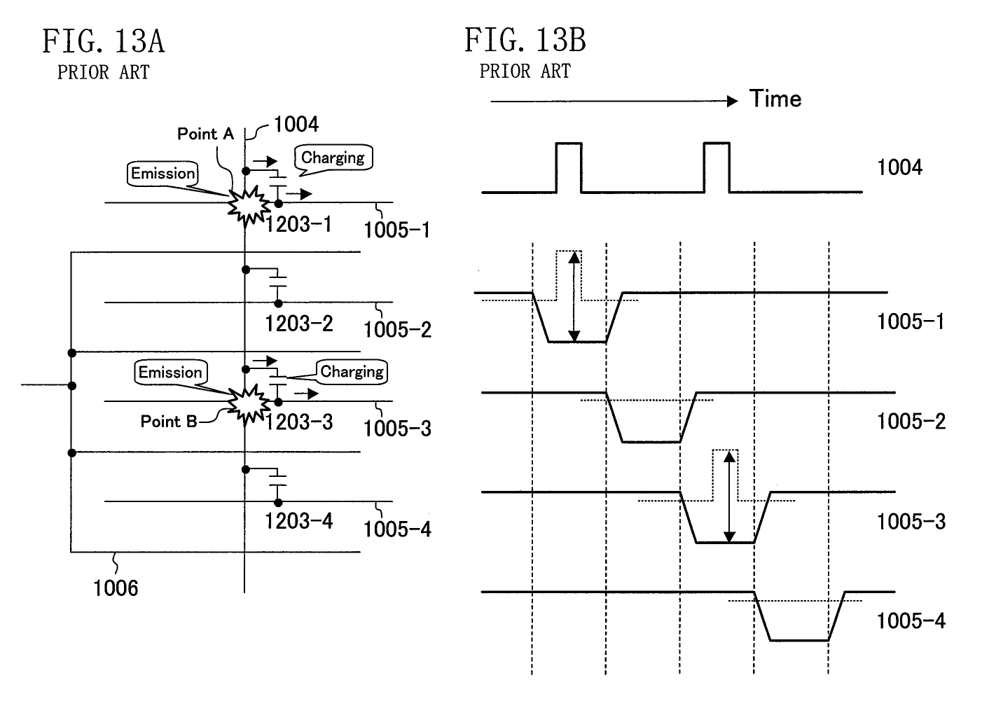

FIG. 14A schematically shows a circuit operation of the conventional PDP on the panel when sustaining the light emission, and FIG. 14B shows waveforms of negative pulses applied to different scanning electrodes.

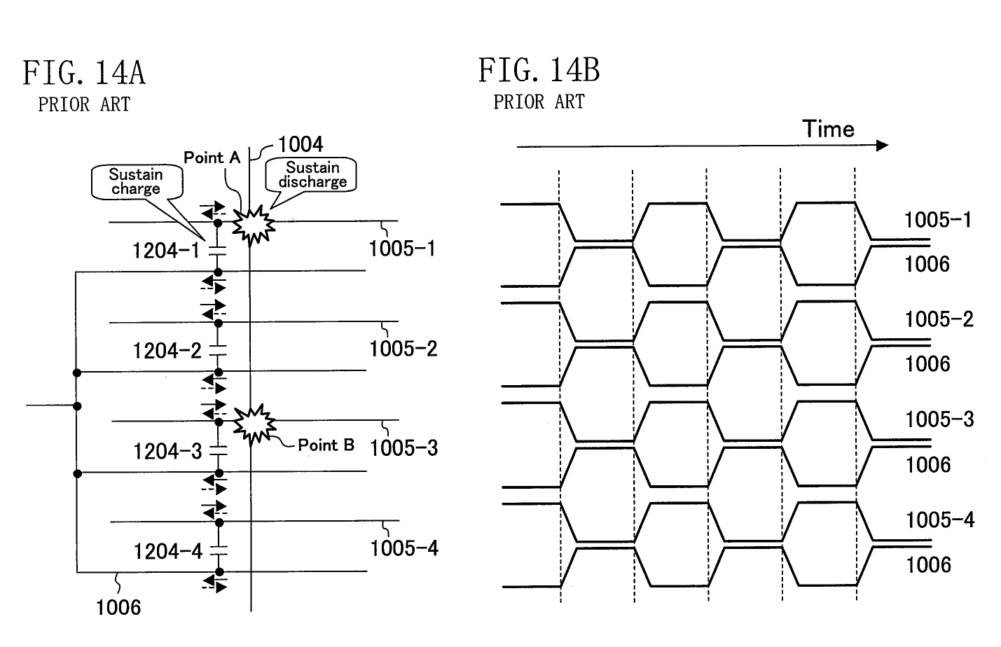

FIG. 15 is a circuit diagram schematically showing a configuration of a second conventional PDP.

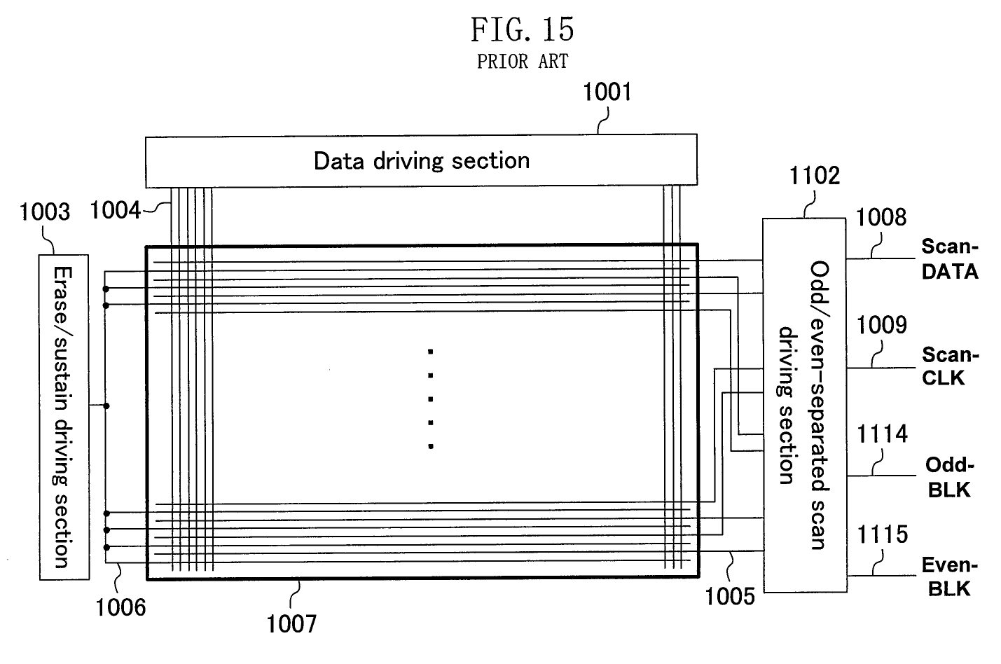

FIG. 16 shows a specific configuration of an odd/even-separated scan driving section of the second conventional PDP.

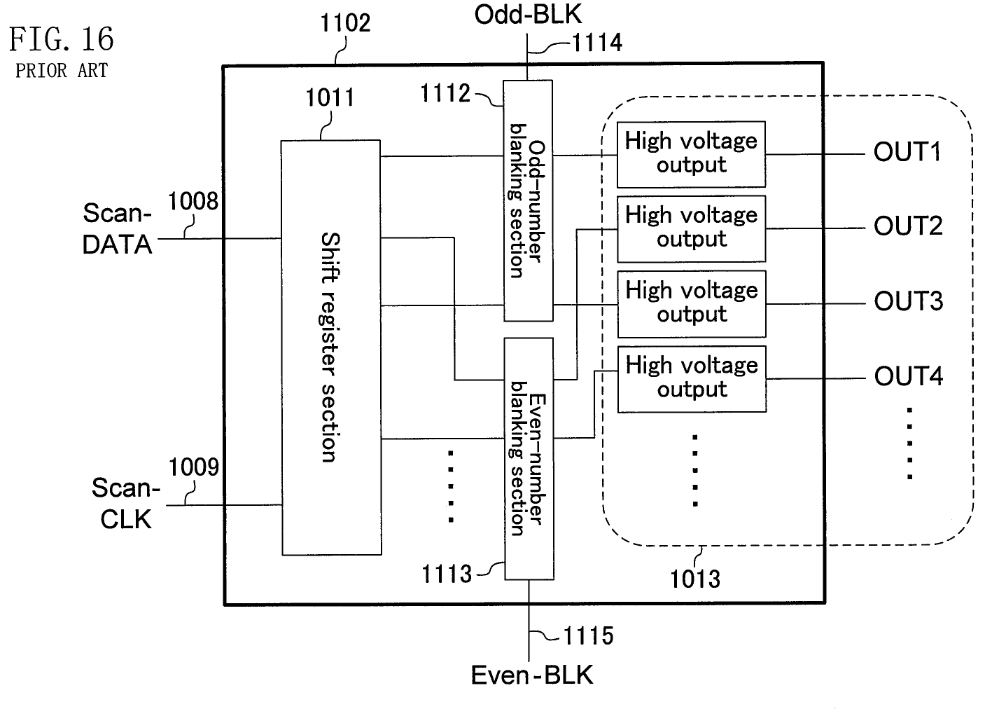

FIG. 17 is a timing diagram showing waveforms of input and output signals of the odd/even-separated scan driving section shown in FIG. 16.

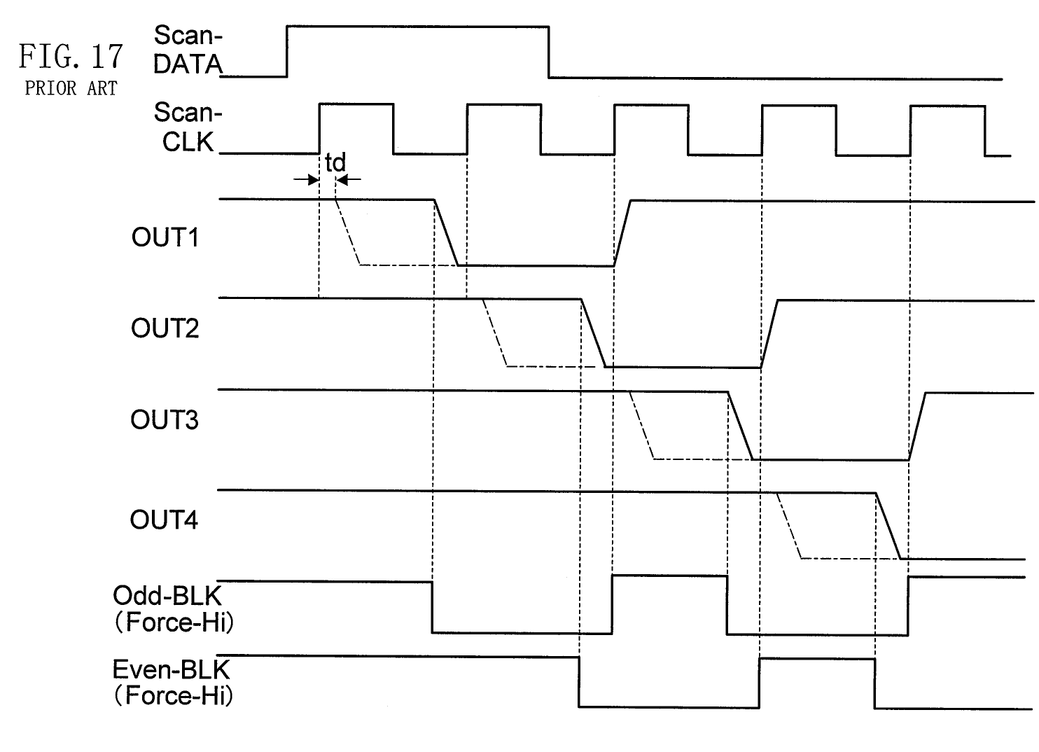

### DESCRIPTION OF THE PREFERRED EMBODIMENTS

Embodiments of the present invention will now be described with reference to the drawings.

### First Embodiment

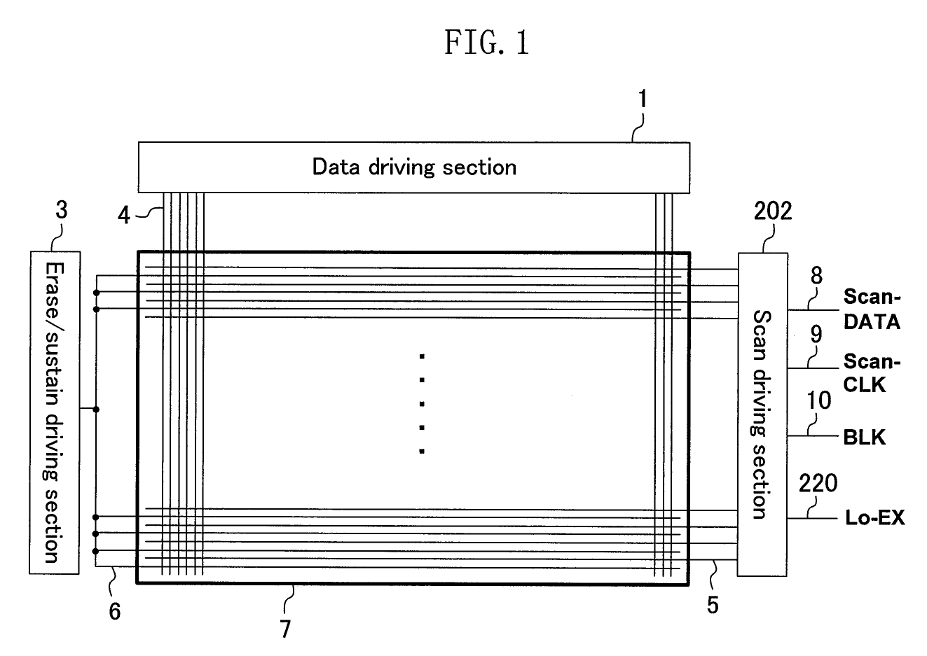

FIG. 1 schematically shows a configuration of a PDP according to a first embodiment of the present invention. Referring to FIG. 1, the PDP of the present embodiment includes a panel (the display section) 7, a plurality of data electrodes 4 arranged on the panel 7, a plurality of scanning electrodes 5 extending across the data electrodes 4, an erase/sustain electrode 6 provided for each of the scanning electrodes 5 and extending across the data electrodes 4, a scan driving section 202 for driving the scanning electrodes 5, a data driving section 1 for driving the data electrodes 4, and an erase/sustain driving section 3 for driving the erase/sustain electrodes 6. Pulses having positive and negative polarities are applied to the scanning electrodes 5. The panel 7 and elements formed thereon, including the scanning electrodes 5, the data electrodes 4 and the erase/sustain electrodes 6, are all capacitive loads as seen from a circuit driving section such as the scan driving section 202.

The scan driving section 202 receives a scan data signal 8, a scan clock signal 9, a scan blanking signal 10, and a negative pulse width control signal 220 being asynchronous with the scan clock signal 9. The scan driving section (a capacitive load driving circuit) 202 of the present embodiment is capable of controlling the width of negative ones of the pulses applied to the scanning electrodes 5 based on the negative pulse width control signal 220.

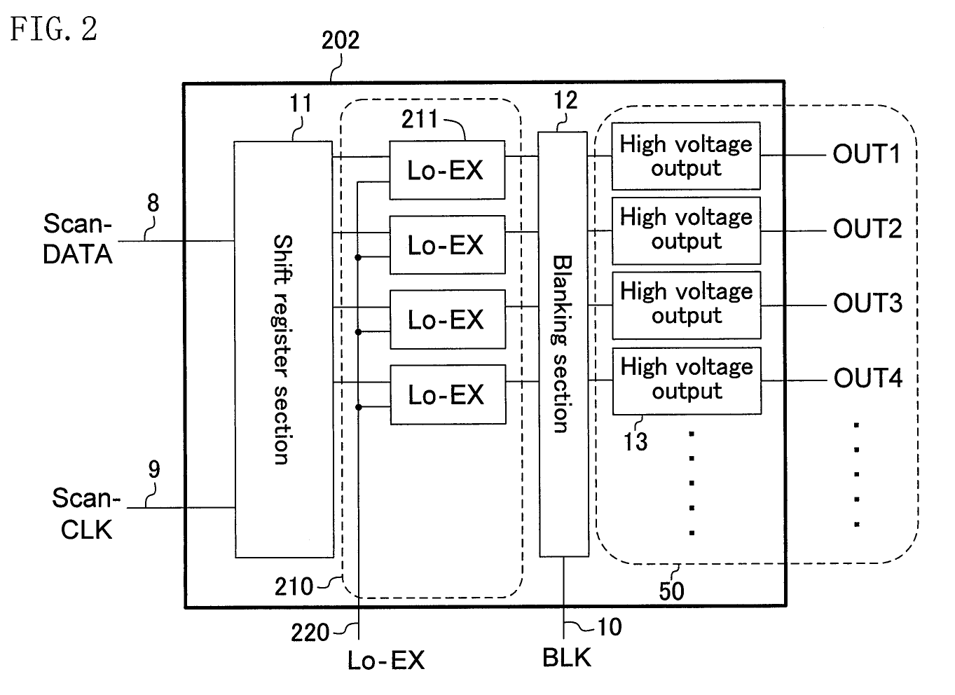

FIG. 2 is a block diagram showing a configuration of the scan driving section 202 in the PDP of the present embodiment. Referring to FIG. 2, the scan driving section 202 capable of controlling the negative pulse width includes a shift register section 11 receiving the scan data signal 8 and the scan clock signal 9, a pulse width control block 210 including a plurality of pulse width control circuits 211 each receiving an output from the shift register section 11 and the negative pulse width control signal 220, a blanking section 12 receiving the outputs from the pulse width control circuits 211 and the scan blanking signal, and a high voltage output block 50 including high voltage output sections 13 receiving the outputs from the blanking section 12 and supplying amplified signals to the corresponding scanning electrodes 5 (see FIG. 1). The pulse width control block 210 includes at least the same number of the pulse width control circuits 211 as the number of the scanning electrodes 5. The blanking section 12 controls the process by, for example, preventing negative pulses from being output, irrespective of the input thereto, during the blanking period.

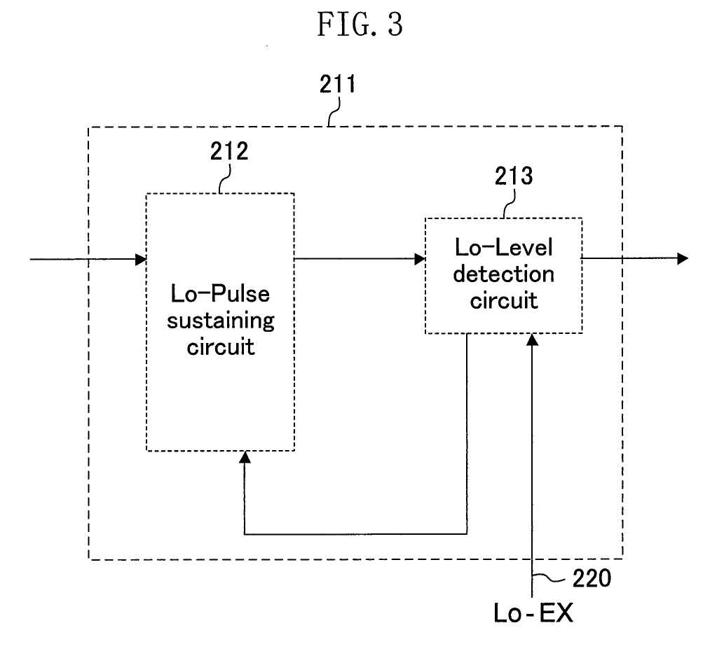

FIG. 3 is a block diagram showing a configuration of the pulse width control circuit 211 in the scan driving section 202 of the present embodiment. Referring to FIG. 3, the pulse width control circuit 211 includes a negative pulse sustaining circuit 212 for determining whether to maintain the current output or to output the same signal as the input signal, and a negative polarity detection circuit 213 receiving the output from the negative pulse sustaining circuit 212 and the negative pulse width control signal 220 to output (feed back) a control signal to the negative pulse sustaining circuit 212.

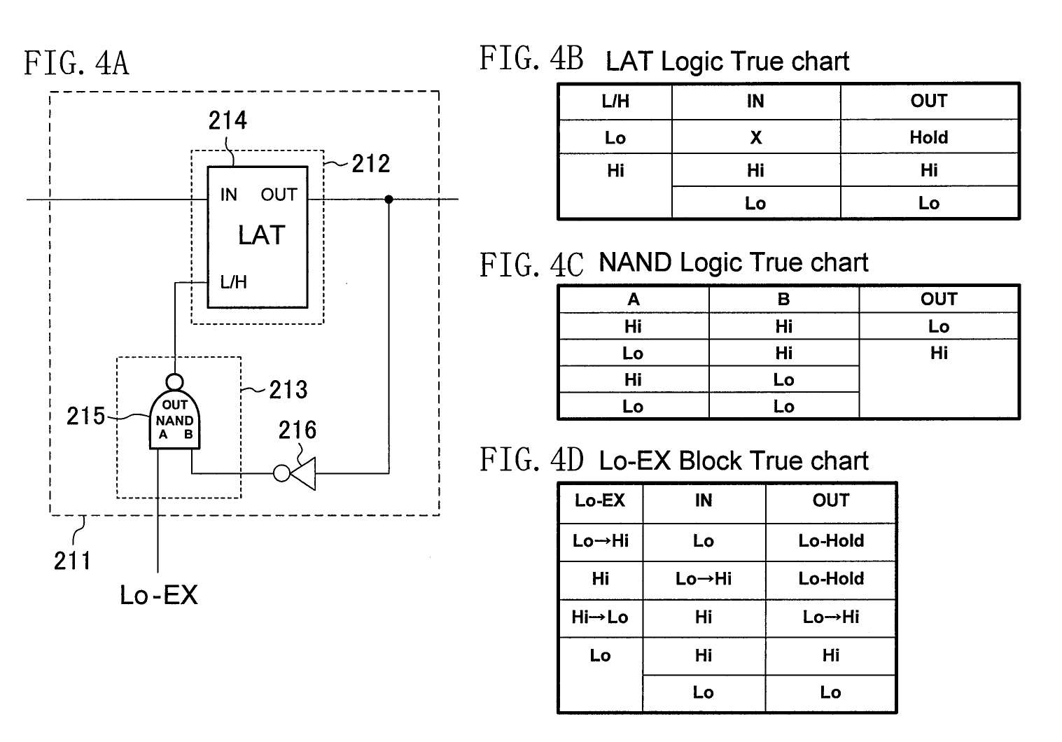

FIG. 4A shows a specific configuration of the pulse width control circuit 211 shown in FIG. 3. In the illustrated example, the negative pulse sustaining circuit 212 is a latch circuit 214 for controlling whether to output the input or to maintain the current output based on an external input, and the negative polarity detection circuit 213 is a NAND logic element 215. A logical inversion of the output of the latch circuit 214 obtained through an inverter element 216 and the negative pulse width control signal 220 are used as the inputs to the NAND logic element 215, and the output of the NAND logic element 215 is used as the control signal for controlling the latch circuit 214.

FIG. 4B is a truth table for the latch circuit 214, FIG. 4C is a truth table for the NAND logic element 215, and FIG. 4D is a truth table for the pulse width control block 210 as a whole.

Referring to FIG. 4B, the latch circuit 214 maintains the current output signal (“Hold”), irrespective of the transitions of the input thereto, if the control signal (the output of the NAND logic element 215) is at the Lo (low) level, and changes its output according to the input signal if the control signal is at the Hi (high) level.

Referring to FIG. 4C, the NAND logic element 215 outputs the Lo level only when the two input signals are both at the Hi level, and outputs the Hi level otherwise.

Referring to FIG. 4D, in the pulse width control circuit 211 of the pulse width control block 210, if the latch circuit 214 outputs the Lo level, it is inverted to the Hi level through the inverter element 216 and the inverted signal is input to the NAND logic element 215, and if the negative pulse width control signal 220 (“Lo-EX” in the figure) is then at the Hi level, the NAND logic element 215 outputs the Lo level. Then, the latch circuit 214 maintains the Lo-level output, irrespective of the transitions of the input signal. Moreover, if the negative pulse width control signal 220 (Lo-EX) transitions from the Hi level to the Lo level, after the input signal to the latch circuit 214 has transitioned to the Hi level, the NAND logic element 215 outputs the Hi level and the latch circuit 214 outputs the Hi level, i.e., the same signal state as the input thereto.

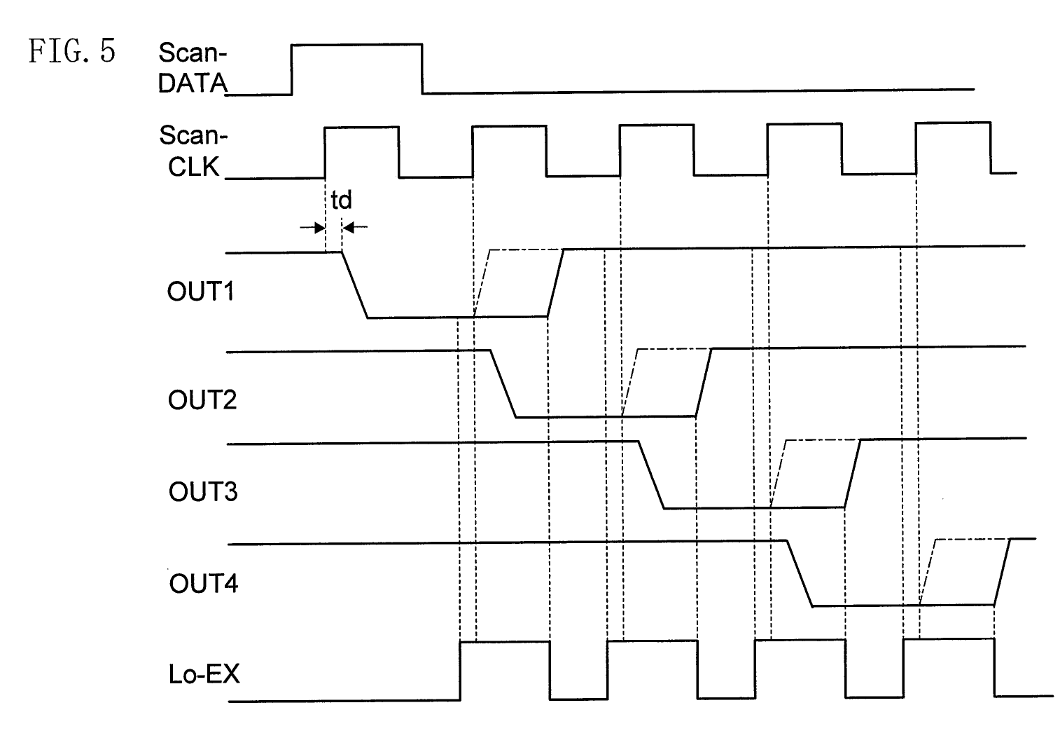

FIG. 5 shows the waveforms of the input and output signals of the scan driving section 202. Referring to FIG. 5, in the scan driving section 202, the scan data signal 8 is transferred by clock cycles based on the scan clock signal 9, and the output terminals OUT1, OUT2, OUT3, OUT4, . . . , sequentially output negative pulses. When a negative pulse is being output, if the negative pulse width control signal 220 at the Hi level is received before the next rising edge of the scan clock signal 9, the particular output holds the negative pulse for the Hi level period of the negative pulse width control signal 220. In the example illustrated in FIG. 5, the Hi level period of the data signal is within the clock cycle, and the output terminals OUT1, OUT2, OUT3, OUT4, . . . , sequentially output negative pulses, each being shifted from the next by one clock cycle, based on the scan clock signal 9. Thus, the rise of the negative pulse is delayed by the length of the Hi-level period of the negative pulse width control signal 220. Therefore, with the scan driving section 202 of the present embodiment, it is possible to obtain a negative pulse having a pulse width equal to or longer than one clock cycle. As a result, the negative pulse output from the output terminal OUT1 can be extended up to immediately before the start of a discharge at the scanning electrode connected to the output terminal OUT2, for example.

With the scan driving section 202 of the present embodiment, it is possible to arbitrarily adjust the width of the negative pulse applied to the scanning electrode, by using the negative pulse width control signal 220 being a single control signal and being asynchronous with the scan clock signal 9. Therefore, adjustments to clock frequency changes, and the like, can be done more easily, as compared with the second conventional PDP. Moreover, even if the clock frequency is increased, the width of the negative pulse can be set to be equal to or longer than one clock cycle, and it is thus possible to ensure a sufficient light emission sustaining time.

Moreover, scanning electrodes of the odd-numbered lines and those of the even-numbered lines will not be driven at the same time, thereby enabling a line-by-line arbitrary adjustment. As a result, even when higher-definition PDPs are introduced and the clock frequency is increased, it is possible to ensure a sufficient negative pulse width. Moreover, the negative pulse width is determined by using one pulse width of a single control signal, enabling subtle adjustments, whereby it is possible to absorb panel-to-panel variations. Thus, it is possible to increase the yield of PDPs and to improve the reliability thereof.

The circuit configuration shown in FIGS. 2 to 4D is merely illustrative, and similar effects to those of the present embodiment can be obtained when the scan driving section uses a different circuit realizing substantially the same operation.

### Second Embodiment

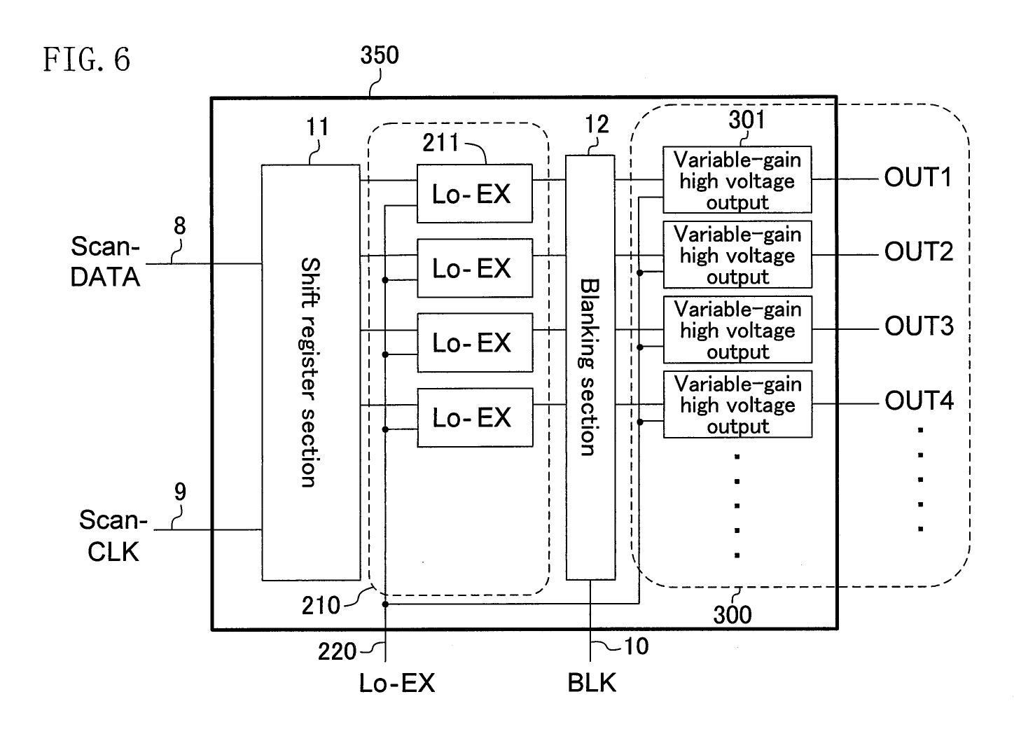

FIG. 6 is a block diagram showing a configuration of a scan driving section (a capacitive load driving circuit) 350 according to a second embodiment of the present invention.

Referring to FIG. 6, the scan driving section 350 of the present embodiment includes variable-gain high voltage output sections 301 in place of the high voltage output sections 13 of the scan driving section 202 shown in FIG. 2, and the configuration thereof is the same as that of the scan driving section 202 except for the variable-gain high voltage output sections 301. A variable-gain high voltage output block 300 includes a number of the variable-gain high voltage output sections 301 corresponding to the scanning electrodes. Each variable-gain high voltage output section 301 receives an output from the blanking section 12, and supplies an output signal to the corresponding scanning electrode.

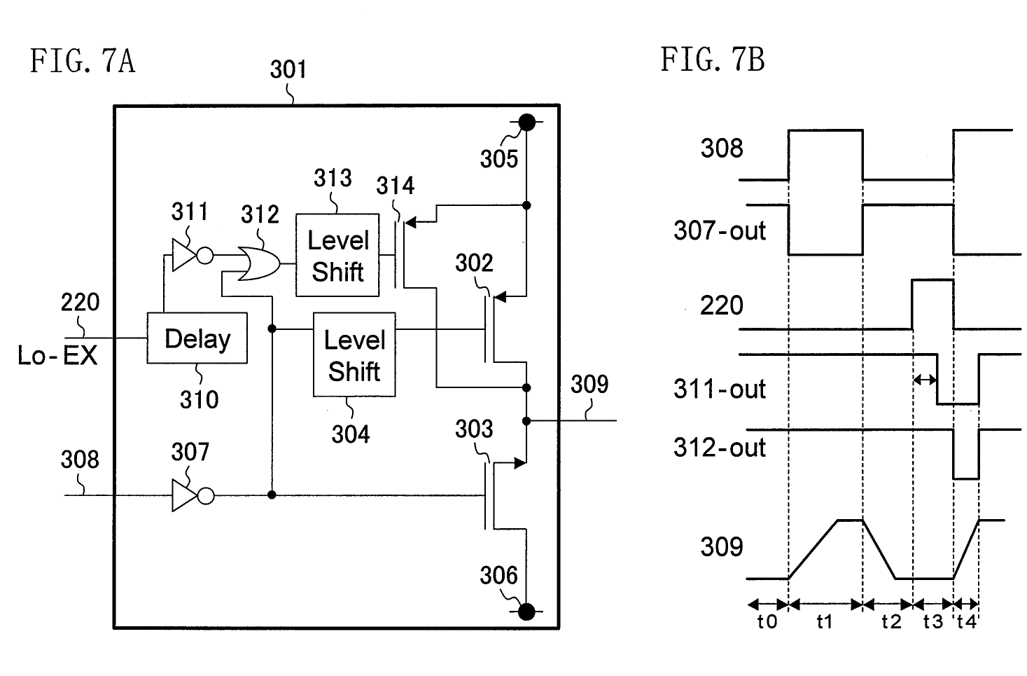

Referring now to FIGS. 7A and 7B, a circuit configuration of the variable-gain high voltage output section 301 and the operation waveforms thereof will be described. FIG. 7A shows a configuration of the variable-gain high voltage output section 301, and FIG. 7B shows signal waveforms of the variable-gain high voltage output section 301.

Referring to FIG. 7A, the variable-gain high voltage output section 301 includes a delay element 310, an inverter element 311, an inverter element 307, an OR logic element 312, a level shift circuit 313, a level shift circuit 304, an Nch switching element (an N-channel MOS transistor) 303, a Pch switching element (a P-channel MOS transistor) 302, and a Pch switching element (a P-channel MOS transistor) 314. The delay element 310 receives the negative pulse width control signal 220. The inverter element 311 logically inverts the output signal from the delay element 310. The inverter element 307 receives a signal 308 output from the blanking section 12 and logically inverts the input signal 308. The OR logic element 312 receives the input signal 308 via the inverter element 307, and also receives the output signal from the delay element 310 via the inverter element 311. The level shift circuit 313 receives the output signal from the OR logic element 312. The level shift circuit 304 receives the input signal 308 via the inverter element 307. The Nch switching element 303 is a switching element whose gate receives the input signal 308, which has been logically inverted through the inverter element 307, and whose source is connected to a negative-polarity power supply 306. The Pch switching element 302 is a switching element whose source is connected to a positive-polarity power supply 305, whose drain is connected to the Nch switching element 303, and whose gate receives the output signal from the level shift circuit 304. The Pch switching element 314 is a switching element whose source is connected to the positive-polarity power supply 305, whose drain is connected to the Nch switching element 303, and whose gate receives the output signal from the level shift circuit 313. An output signal 309 is output from a node between the drains of the Pch switching elements 302 and 314 and the drain of the Nch switching element 303. The Nch switching element 303 is a switch for triggering down the output signal 309, and the Pch transistor elements 302 and 314 are a switch for triggering up the output signal 309.

In the variable-gain high voltage output section 301 having such a configuration, the negative pulse width control signal 220 is delayed by a predetermined amount of time through the delay element 310, then inverted through the inverter element 311, and input to the OR logic element 312 together with the output signal from the inverter element 307. Referring now to FIG. 7B, specific operation waveforms of the variable-gain high voltage output section 301 will be described in order of time.

First, in period t0, the input signal 308 is at the Lo level and the output from the inverter element 307 (“307-out” in FIG. 7B) is at the Hi level, whereby the gate of the Pch switching element 302 and that of the Nch switching element 303 both receive a Hi-level signal. Thus, the Pch switching element 302 is turned OFF, and the Nch switching element 303, which is connected to the negative-polarity power supply 306, is turned ON. Since the negative pulse width control signal 220 remains at the Lo level, the output from the inverter element 311 (“311-out” in FIG. 7B) is at the Hi level. An OR logic element outputs the Hi level if one or both of the inputs are at the Hi level, and the Pch switching element 314 whose gate receives the Hi level is OFF. Therefore, the output signal 309 is at the Lo level.

Then, in period t1, the input signal 308 transitions from the Lo level to the Hi level, and the output from the inverter element 307 accordingly goes to the Lo level. As a Lo-level signal is input to the gate of the Pch switching element 302 and that of the Nch switching element 303, the Pch switching element 302 transitions from OFF to ON and the Nch switching element 303 transitions from ON to OFF. As a current is discharged from the Pch switching element 302, the output signal 309 goes to the Hi level. It is known in the art that there is a parasitic capacitance along the path of the output signal 309, and that the output signal 309 therefore rises with some gradient according to the current capacity. During period t1, the Pch switching element 314 is OFF.

Then, in period t2, the input signal 308 transitions from the Hi level to the Lo level, and the output of the inverter element 307 accordingly goes to the Hi level. As a result, a Hi-level signal is input to the gate of the Pch switching element 302 and that of the Nch switching element 303. Thus, the Pch switching element 302 transitions back from ON to OFF and the Nch switching element 303 transitions back from OFF to ON. Thus, the output signal 309 goes to the Lo level.

Then, in period t3, the negative pulse width control signal 220 transitions from the Lo level to the Hi level. Therefore, the output of the inverter element 311 goes to the Lo level after being delayed through the delay element 310, and is input to the OR logic element 312. The output of the inverter element 307, being the other input to the OR logic element 312, remains at the Hi level, unchanged from period t2. Therefore, the output of the OR logic element 312 remains at the Hi level, and the gate of the Pch switching element 314 keeps receiving the Hi level, whereby the Pch switching element is OFF. Thus, the output signal 309 remains unchanged after transitioning to the Lo level in period t2.

Then, in period t4, the negative pulse width control signal 220 transitions from the Hi level to the Lo level and the input signal 308 transitions from the Lo level to the Hi level. Therefore, the output of the inverter element 307 goes to the Lo level, whereby a Lo-level signal is input to the gate of the Pch switching element 302 and that of the Nch switching element 303. Therefore, the Pch switching element 302 transitions from OFF to ON, and the Nch switching element 303 transitions from ON to OFF. Then, in addition to the Pch switching element 302 discharging a current, the output of the inverter element 311 transitions from the Lo level to the Hi level with a delay through the delay element 310 from the transition of the negative pulse width control signal 220. As a result, during the delay period (period t4) due to the delay element 310, the output of the inverter element 311 and the output of the inverter element 307, which are the inputs to the OR logic element 312, are both at the Lo level. Therefore, the OR logic element 312 outputs the Lo level and the signal passes through the level shift circuit 313, whereby the gate of the Pch switching element 314 transitions from the Hi level to the Lo level, thus turning ON the Pch switching element 314. Therefore, during period t4, a current is supplied to the output signal 309 both from the Pch switching elements 302 and 314, and the output signal 309 transitions from the Lo level to the Hi level with a sharper gradient than that during period t1. There is a parasitic capacitance, etc., along the path of the output signal 309, and the output signal 309 therefore rises with some gradient according to the current capacity.

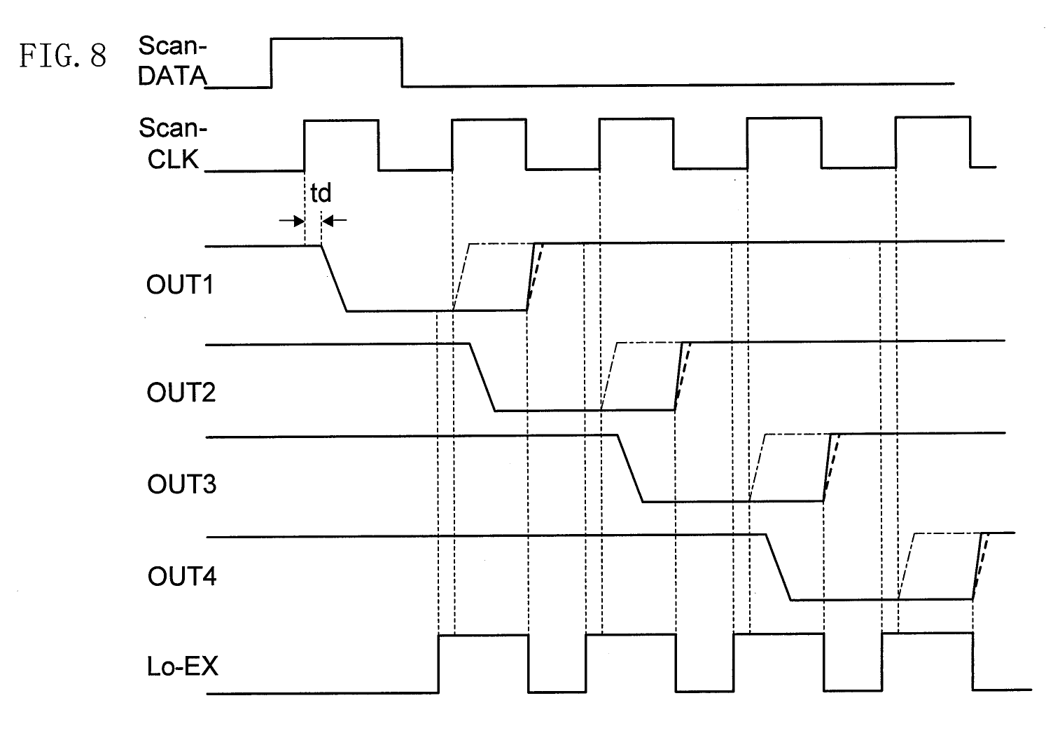

FIG. 8 shows waveforms of input and output signals of the scan driving section according to the second embodiment of the present invention.

With the scan driving section of the present embodiment, the timing of falling and the timing of rising of the output signals with respect to the scan clock signal (Scan-CLK), the scan data signal (Scan-DATA) and the negative pulse width control signal (Lo-EX), etc., are the same as those with the scan driving section of the first embodiment shown in see FIG. 5. However, where there is obtained a pulse width equal to or longer than one clock cycle using the negative pulse width control signal 220, the gain (or the output impedance) of the variable-gain high voltage output section 301 being an amplifier circuit can be changed by using the negative pulse width control signal for a predetermined period of time at the rise of the negative pulse. Thus, the gradient of the rising edge of the negative pulse can be made sharper than that obtained with the scan driving section of the first embodiment, whereby it is possible to shorten the amount of time required for the negative pulse to rise. This makes it possible to make more use of the pulse width. For example, the acceptable pulse width can be increased.

The configuration shown in FIGS. 6 to 7B is merely illustrative, and the circuit configuration is not limited to those particular examples as long as it is possible to realize substantially the same operation and effect.

Thus, the present invention can be used in a driving circuit for a multi-channel semiconductor integrated circuit for driving a capacitive load, such as a PDP.

What is claimed is:

1. A scanning capacitive load driving circuit for driving a plurality of lines of scanning electrodes arranged in a display section, comprising:
a shift register section receiving a scan data signal and a scan clock signal;
a plurality of pulse width control circuits each receiving an output signal from the shift register section and a negative pulse width control signal to output a signal whose pulse width is controlled based on the negative pulse width control signal;
a blanking section receiving the output signals from the plurality of pulse width control circuits and a blanking signal; and
a plurality of high voltage output sections for amplifying the output signals from the plurality of pulse width control circuits, which are received via the blanking section, to successively output negative pulses each having a controlled pulse width to the corresponding lines of scanning electrodes.

2. The scanning capacitive load driving circuit of claim 1, wherein:
the scan data signal is synchronous with the scan clock signal;
the negative pulse width control signal is asynchronous with the scan clock signal; and
each of the plurality of pulse width control circuits includes a negative pulse sustaining circuit receiving the scan data signal via the shift register section, and a negative polarity detection circuit receiving an output signal of the negative pulse sustaining circuit and the negative pulse control signal.

3. The scanning capacitive load driving circuit of claim 2, wherein the negative pulse sustaining circuit is a latch circuit, and the negative polarity detection circuit is a NAND logic element.

4. The scanning capacitive load driving circuit of claim 1, wherein a rising edge of the negative pulse applied to the scanning electrode is synchronous with a rising edge of the negative pulse width control signal.

5. The scanning capacitive load driving circuit of claim 1, wherein a gain of the high voltage output section is varied based on the negative pulse width control signal for a predetermined period of time when the negative pulse rises.

6. The scanning capacitive load driving circuit of claim 5, wherein the high voltage output section includes a first P-channel switching element whose source is connected to a positive-polarity power supply, a second P-channel switching element which is connected in parallel to the first P-channel switching element and whose source is connected to the positive-polarity power supply, and an N-channel switching element whose source is connected to a negative-polarity power supply and whose drain is connected to drains of the first P-channel switching element and the second P-channel switching element, and wherein the first P-channel switching element and the second P-channel switching element are both ON only when the negative pulse rises.

7. A plasma display panel, comprising:
a display section;
a plurality of lines of scanning electrodes arranged in the display section, wherein at least negative pulses are applied to the scanning electrodes;
a plurality of lines of erase/sustain electrodes arranged in the display section;
scan data electrodes extending across the scanning electrodes and the erase/sustain electrodes; and
a scanning capacitive load driving circuit for driving the scanning electrodes, wherein the scanning capacitive load driving circuit includes:
a shift register section receiving a scan data signal and a scan clock signal;
a plurality of pulse width control circuits each receiving an output signal from the shift register section and a negative pulse width control signal to output a signal whose pulse width is controlled based on the negative pulse width control signal;
a blanking section receiving the output signals from the plurality of pulse width control circuits and a blanking signal; and
a plurality of high voltage output sections for amplifying the output signals from the plurality of pulse width control circuits, which are received via the blanking section, to successively output the negative pulses each having a controlled pulse width to the corresponding lines of scanning electrodes.

8. The plasma display panel of claim 7, wherein:
the scan data signal is synchronous with the scan clock signal; and
the negative pulse width control signal is asynchronous with the scan clock signal.

9. The plasma display panel of claim 7, wherein a gain of the high voltage output section is varied based on the negative pulse width control signal for a predetermined period of time when the negative pulse rises.
